(19) United States
(12) Patent Application Publication
(10) Pub. No.: US 2024/0248240 A1
(43) Pub. Date: Jul. 25, 2024

(54) EMBEDDED, SLANTED OPTICAL GRATING STRUCTURES

(71) Applicant: NIL Technology ApS, Kongens Lyngby (DK)

(72) Inventor: Niklas Hansson, Askim (SE)

(21) Appl. No.: 18/693,410

(22) PCT Filed: Sep. 16, 2022
(86) PCT No.: PCT/EP2022/075776

§ 371 Date: Mar. 19, 2024

Related U.S. Application Data
(60) Provisional application No. 63/246,053, filed on Sep. 20, 2021.

(51) Int. Cl. G02B 5/18

(52) U.S. Cl. CPC G02B 5/1842; G02B 5/1852

(57) ABSTRACT

An apparatus is disclosed that includes an optical grating that has embedded, slanted optical grating structures. Methods of fabricating optical gratings also are disclosed.

### FIELD OF THE DISCLOSURE

The present disclosure relates to optical grating structures.

### BACKGROUND

Slanted optical gratings can be used, for example, in applications where efficient redirecting of light is important. One application for slanted gratings is for transparent waveguides in augmented reality (AR) and mixed reality (MR) head mounted displays, where light from an image generator is coupled into the waveguide at one end and coupled out of the waveguide and directed to the eye of the observer at the other end. The gratings act as high efficiency in- and out coupling gratings. In addition to waveguides, slanted gratings may be used in any application, where high efficiency of a single diffraction order is desired.

Various techniques are available to fabricate slanted gratings. However, in some cases, the techniques are complicated and require expensive equipment, which can lead to high production costs. Further, although high-angle gratings can be useful for augmented reality and other applications, high-angle gratings can be difficult to fabricate because, during replication, the grating's “fins” break off when the master is demolded.

### SUMMARY

The present disclosure describes optical gratings and methods of manufacturing the optical gratings.

For example, in one aspect, this disclosure describes an apparatus that includes an optical grating including a plurality of embedded, slanted optical grating structures. Some implementations include one or more of the following features. For example, the grating structures can have a refractive index that is higher than a refractive index of the material in which the grating structures are embedded. In some implementations, the grating structures are composed of an inorganic material. The grating structures can be embedded, for example, within a lithography resist (e.g., a polymethyl methacrylate or other resist). In some instances, the grating structures are slanted with respect to outer surfaces of the lithography resist. More generally, the grating structures can be embedded within a material and can be slanted with respect to outer surfaces of the material. In some instances, the grating structures are embedded within at least one cured material.

In some implementations, the optical grating is disposed on a support that has a stepped perimeter. In some cases, at least part of the stepped perimeter is covered by a material within which the grating structures are embedded.

In some implementations, the optical grating is mounted on a flexible layer. For example, in some cases, the flexible layer is composed of a UV-release or thermal-release dicing tape.

The present disclosure also describes a method that includes pressing a surface of an imprint tool into an imprint material to form an imprinted structure including grating supports composed of the imprint material. The imprint material is disposed over a substrate, and the grating supports are inclined with respect to a plane of the substrate. The method further includes covering at least a portion of each of the grating supports with a deposition material to form optical grating structures.

In some implementations, the method further includes depositing a backfill material onto the grating supports and the grating structures to cover previously exposed surfaces of the grating structures so that the grating structures are embedded between the imprint material and the backfill material, and are inclined with respect to the plane of the substrate.

Some implementations include one or more of the following features. For example, in some implementations, the deposition material is an inorganic material. In some cases, the backfill material has the same composition as the imprint material. The imprint material can comprise, for example, a lithography resist.

In some instances, covering a portion of each of the grating supports with a deposition material includes performing an angled deposition in which the deposition material is evaporated onto the portion of each of the grating supports. Performing an angled deposition can include, for example, resistive or e-beam evaporation.

In some implementations, the grating structures have a refractive index that is higher than a refractive index of the imprint material and the backfill material.

In some implementations, the method includes removing the substrate after depositing the backfill material.

Some implementations include one or more of the following advantages. For example, in some implementations, it is easier to form the grating support structures because there is no overhang, which can make demolding easier compared to situations in which the slanted structures are formed directly in an imprinting step. Further, as noted above, in some cases the optical gratings can be composed of an inorganic material. This can be advantageous because inorganic materials tend to have higher indices of refraction, tend to be more thermally stable (e.g., less prone to degradation with temperature), and tend to have lower thermal expansion than organic materials that typically are used in replication processes.

The details of one or more implementations are set forth in the accompanying drawings and the description below. Other aspects, features and advantages will be apparent from the following detailed description, the accompanying drawings, and the claims.

### BRIEF DESCRIPTION OF THE DRAWINGS

FIG. 1 illustrates an example of a waveguide display including slanted optical gratings.

FIGS. 2A-2H illustrate stages in a method of fabricating embedded slanted optical gratings.

FIGS. 3A-3D illustrate stages in another method of fabricating embedded slanted optical gratings.

FIGS. 4A through 4I stages in yet another method of fabricating embedded slanted optical gratings.

### DETAILED DESCRIPTION

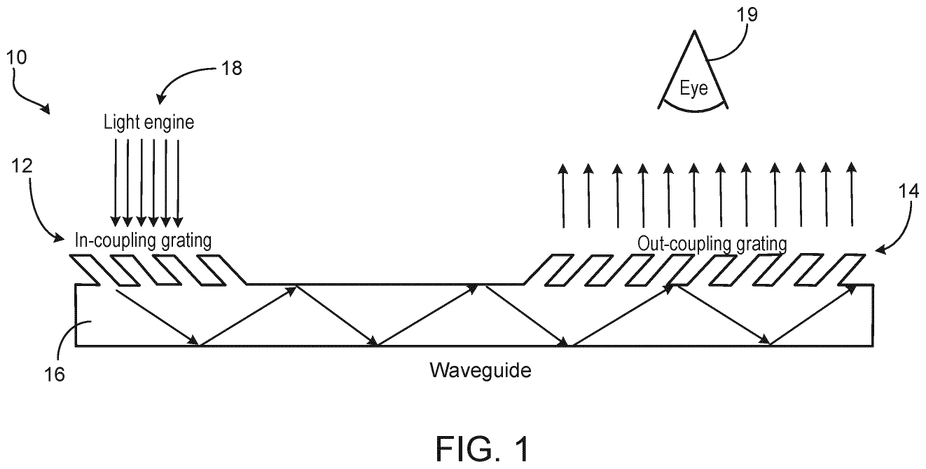

FIG. 1 illustrates an example of an arrangement of slanted optical gratings in a waveguide display 10. The waveguide display 10 includes surface relief gratings (SRGs) in the form of slanted grating structures 12, 14 disposed on an optical waveguide or other substrate 16. The grating structures 12 serve as an in-coupling grating that receive light from a light engine 18, and the grating structures 14 serve as an out-coupling grating to direct light, for example, to user's eye 19. The grating structures can have a particular width, depth, slant angle, and period. The spectral and angular bandwidths of the gratings can be tuned, for example, by selection of the slant angle. An optical advantage of slanted gratings is that by proper choice of dimensions, tilt angle and material, most of the light can be directed into a single diffraction order.

In some instances, it can be advantageous to provide an embedded optical grating structure. The present disclosure describes various methods for fabricating embedded optical gratings that incorporate slanted gratings structures.

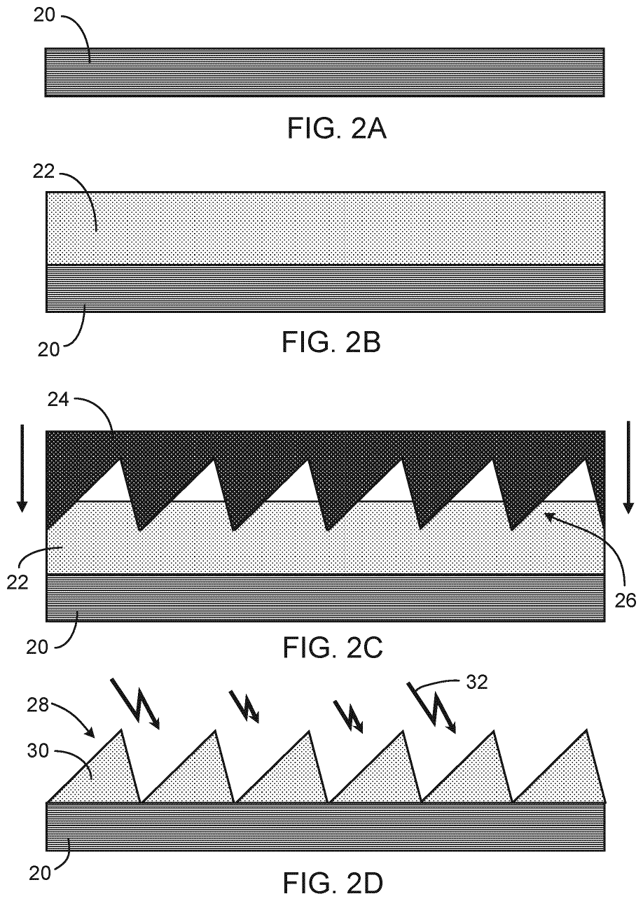

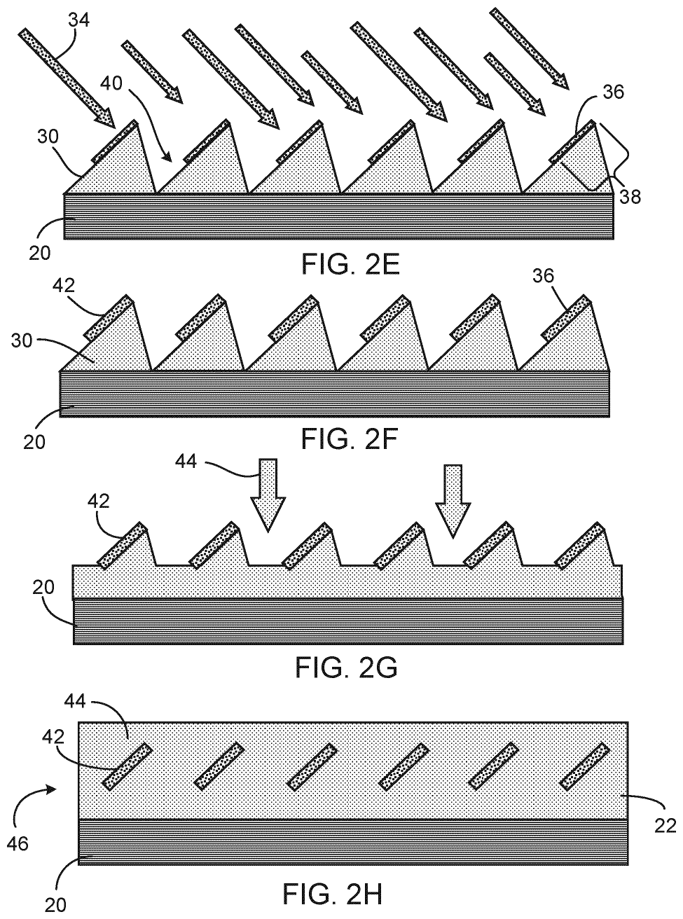

FIGS. 2A through 2H illustrate stages in a first fabrication method. As shown in FIG. 2A, a substrate (e.g., a wafer) 20 is provided and serves as a support for the subsequently formed optical grating. The substrate 20 can be composed, for example, of crystalline or polycrystalline silicon, glass, or fused silica. Other materials may be appropriate for some implementations. Next, as shown in FIG. 2B, a layer of imprint material 22 is deposited on the substrate 20. The imprint material 22 can be any material capable of being imprinted and cured. For example, in some implementations, the imprint material 22 is a lithography resist (e.g., a polymethyl methacrylate (“PMMA”) resist). For some applications, the imprint material 22 should have a relatively low refractive index. For example, in some instances, the imprint material 22 has a refractive index in the range of 1.2-1.6. The imprint material 22 can be deposited, for example, by spin coating or drop coating. Other techniques for providing the imprint material 22 on the substrate 20 can be used as well.

As shown in FIG. 2C, an imprint tool 24 is pressed into the imprint material 22. The surface of the imprint tool 24 that is pressed into the imprint material 22 defines a negative 26 of an optical grating structure. As shown in FIG. 2D, pressing the tool 24 into the imprint material 22 forms an imprinted structure 28 that includes individual grating supports 30 composed of the imprint material. The grating supports 30, which are composed of the imprint material and can have a relatively high slant angle (e.g., 40° to 70° from normal), then are cured (e.g., by ultra-violet (UV) and/or thermal curing). In some instances, the curing process is performed while the tool 24 is still pressed into the imprint material 22. In some instances, UV curing may be performed while the tool 24 is still pressed into the imprint material 22, and thermal curing subsequently can be performed after the tool 24 is removed to fully cure the imprint material.

As further indicated by FIG. 2D, after curing, the imprinted structure 28 can be subjected to a brief etch treatment 32 to clean its surface. In some implementations, the etch treatment is a de-scum etch (e.g., an oxygen plasma etch).

Next, as indicated by FIG. 2E, the grating supports 30 are subjected to an angled deposition 34 in which a deposition material 36 is evaporated onto at least a portion 38 of the angled surface of each of the individual grating supports 30. Resistive or e-beam evaporation can be used in some implementations. Preferably, the deposition material 36 should have a relatively high refractive index. For example, in some instances, the deposition material 36 has a refractive index in the range 1.7-3.6. In some implementations, the deposition material 36 is composed of an inorganic material. This can be advantageous because inorganic materials tend to have higher indices of refraction, tend to be more thermally stable (e.g., less prone to degradation with temperature), and tend to have lower thermal expansion than organic materials that typically are used in replication processes. In some instances, for example, the deposition material 36 is Al₂O₃, which has an index of refraction of about 1.7.

In some implementations, because deposition of the material 36 occurs at an angle, each of the individual grating supports 30 casts a shadow 40 on an adjacent individual grating support such that only a portion 38 of each individual grating support is covered by the deposition material. In some instances, the deposition material 36 is evaporated onto the entire upper surface of the gratings supports 30 (i.e., as if there were no shadow effect). As illustrated in FIG. 2F, the deposition material 36 deposited by angled deposition 34 forms a respective slanted optical grating structure 42 on each of the individual grating supports 30. That is, the grating structures 42 are slanted with respect to the plane of the substrate 20. In some instances, each of the grating structures 42 forms a relatively high angle relative to the plane of the substrate (e.g., 40° to 95° from normal).

In some implementations, further fabrication steps are performed to embed the slanted grating structures 42 between the imprint material and a backfill material. For example, as indicated by FIG. 2G, a backfill material 44 can be deposited onto the individual grating supports 30 and grating structures 42. The backfill material 44 can be deposited, for example, by spin coating or drop coating, although other techniques can be used in some implementations. Further, in some implementations, the backfill material 44 has the same composition as the imprint material 22. For example, the backfill material 44 in some cases is a lithography resist (e.g., a polymethyl methacrylate (“PMMA”) resist). As shown in FIG. 2H, the backfill material 44 can be provided so that it completely covers the previously exposed surfaces of the grating structures 42. That is, the backfill material 44 is deposited such that the slanted grating structures 42 are embedded between the imprint material 22 and the backfill material 44. The backfill material 44 then can be cured (e.g., by UV and/or heat). The result, as shown in FIG. 2H, is an embedded optical grating 46 that includes slanted grating structures 42.

The embedded optical grating 46 of FIG. 2H includes multiple slanted grating structures 42 each of which is embedded between the imprint material and the backfill material. Collectively, the grating structures 42 can form, for example, a periodic, repetitive structure and can be composed, for example, of an inorganic material. As noted above, in some instances, the same material is used for the imprint material and the backfill material, such that the grating structures 42 are embedded within a single material (e.g., a lithography resist). The refractive index of the slanted grating structures 42 can be higher than the refractive index of the material in which the grating structures are embedded (i.e., higher than the refractive index of the imprint material and the backfill material). In the example of FIG. 2H, the optical grating 46 is supported by the substrate 20. In some implementations, however, as described below, the substrate 20 may be removed.

In some implementations, the optical grating 46 of FIG. 2H may be singulated (e.g., by dicing in a direction perpendicular to the plane of the substrate 20) to form multiple, smaller optical grating structures. However, as the embedded optical grating is disposed between the imprint and backfill materials, the imprint material and/or backfill material may tear way during the dicing. The following paragraphs describe a technique that, in some instances, can address this challenge.

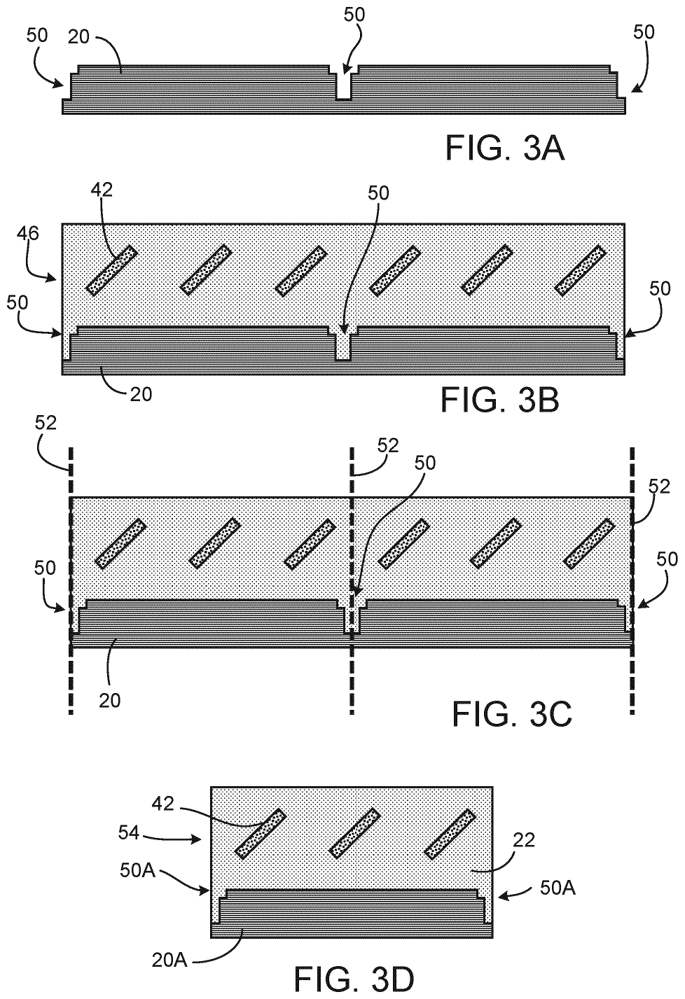

As shown in FIG. 3A, one or more tear-out arrestors 50 are provided in the substrate 20 prior to deposition of the imprint material 22. The tear-out arrestors 50 can take the form of trenches and can be formed (e.g., by etching) at locations where the substrate 20 is to be diced during the singulation. In some instances, the tear-out arrestors 50 are formed as stepped trenches, as shown in FIG. 3A. Fabrication of the optical grating then can proceed as described above in connection with FIGS. 2B through 2H. The resulting embedded optical grating 46 is shown in FIG. 3B and is similar to that of FIG. 2H. However, in the example of FIG. 3B, the optical grating 46 is supported by a substrate 20 that includes the tear-out arrestors 50.

As illustrated in FIG. 3C, the embedded optical grating 46 of FIG. 3B can be subjected to singulation (e.g., dicing along the dicing lines 52) to form individual embedded optical gratings 54 as depicted in FIG. 3D. In some instances, the substrate 20A that supports the individual embedded optical grating 54 has a stepped perimeter 50A that is at least partially covered or encased by the imprint material 22.

In some implementations, it can be advantageous to provide a release layer such that the embedded optical grating can be released from the substrate. An advantage of this approach in some cases is that the imprint material 22 can be flexible once cured such that the gratings are mounted on a flexible layer. Embedding can help to prevent delamination of the deposition material 36 when the entire grating is bent/flexed.

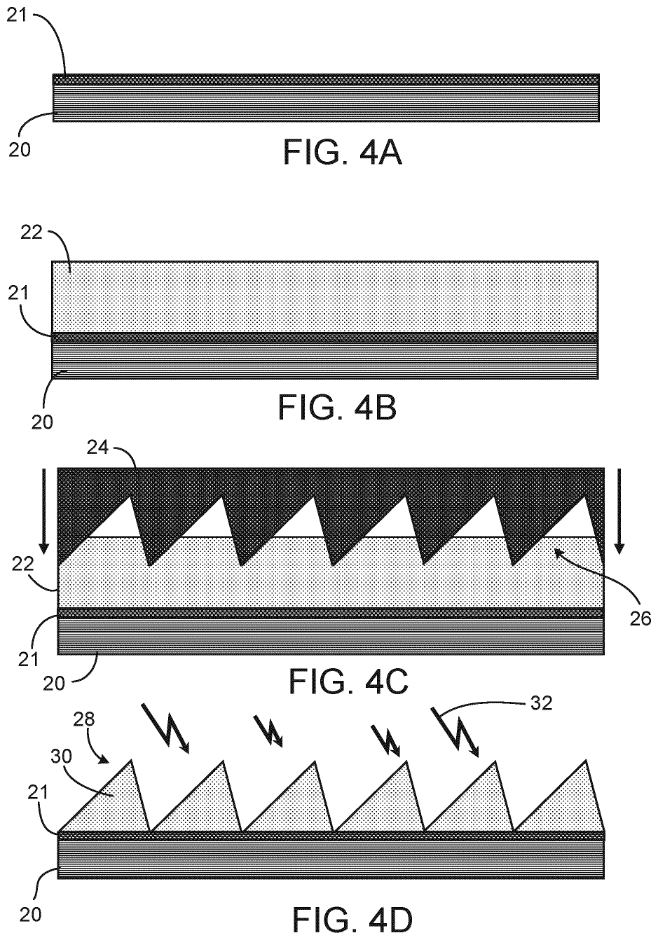

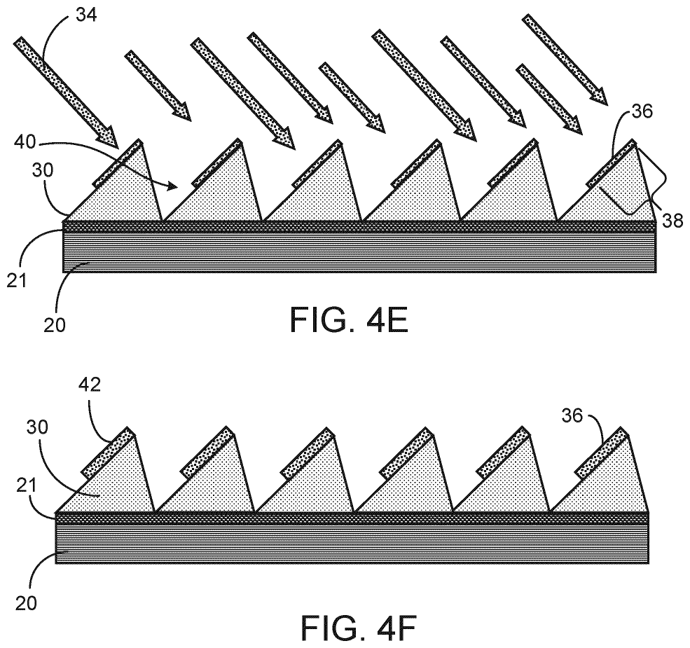

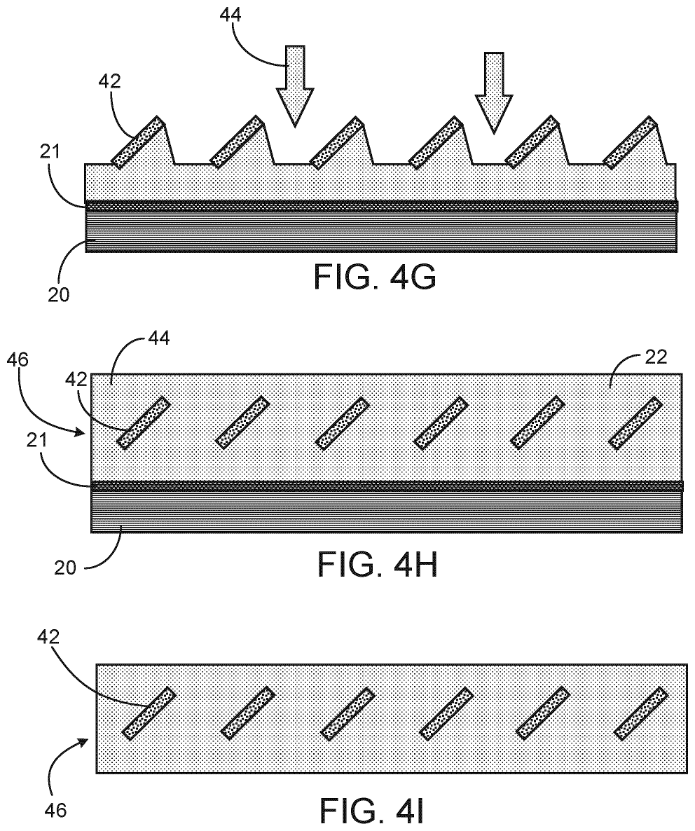

FIGS. 4A through 4I illustrate an example fabrication method in which a release layer 21 is provided on the substrate 20. The release layer 21 can be composed, for example, of UV-release or thermal-release dicing tape or other flexible film. Together, the substrate 20 and release layer 21 serve as a support during formation of the optical grating. The fabrication steps illustrated by FIGS. 4B through 4H correspond, respectively, to the fabrication steps described in connection with FIGS. 2B through 2H. Thus, a layer of imprint material 22 is deposited on the release layer 21 (FIG. 4B), and an imprint tool 24 is pressed into the imprint material 22 (FIG. 4C). Pressing the tool 24 into the imprint material 22 forms an imprinted structure 28 that includes individual grating supports 30 composed of the imprint material. The grating supports 30 then are cured (e.g., by ultra-violet (UV) and/or thermal curing). After curing, the imprinted structure 28 can be subjected to a brief etch treatment 32 to clean its surface (FIG. 4D).

Next, the grating supports 30 are subjected to an angled deposition 34 in which a deposition material 36 is evaporated onto at least a portion 38 of the angled surface of each of the individual grating supports 30 (FIG. 4E). The deposition material 36 deposited by angled deposition 34 forms a respective slanted optical grating structure 42 on each of the individual grating supports 30 (FIG. 4F). In some instances, each of the grating structures 42 forms a relatively high angle relative to the plane of the substrate (e.g., 40° to 70° from normal). Next, a backfill material 44 is deposited onto the individual grating supports 30 and grating structures 42 (FIG. 4G). In some implementations, the backfill material 44 has the same composition as the imprint material 22 (e.g., a lithography resist). The backfill material 44 can be provided so that it completely covers the previously exposed surfaces of the grating structures 42 (FIG. 4H). That is, the backfill material 44 is deposited such that the slanted grating structures 42 are embedded between the imprint material 22 and the backfill material 44. The backfill material 44 then can be cured (e.g., by UV and/or heat). Further details regarding the steps and materials in FIGS. 4B through 4H can be the same as described in connection with FIGS. 2B through 2H. The embedded optical grating 46 then can be released from the substrate 20 (FIG. 4I). For example, if the release layer 21 is composed of UV- or thermal-release tape, UV radiation or heat can be applied to release the grating from the substrate.

The resulting embedded optical grating 46 of FIG. 4I includes multiple slanted grating structures 42 each of which is embedded between the imprint material and the backfill material. The grating structures 42 are slanted with respect to the outer surface(s) of the material 22, 44 in which they are embedded. Collectively, the grating structures 42 can, in some instances, form a periodic, repetitive structure and can be composed, for example, of an inorganic material. As noted above, in some instances, the same material is used for the imprint material and the backfill material, such that the grating structures 42 are embedded within a single material (e.g., a lithography resist). The refractive index of the slanted grating structures 42 can be higher than the refractive index of the material in which the grating structures are embedded (i.e., higher than the refractive index of the imprint material and the backfill material).

Various modifications will be readily apparent. Further, although the foregoing examples show various process steps being performed in a particular order, in some cases, the order may changed in some implementations. Accordingly, other implementations also are within the scope of the claims.

1. An apparatus comprising:
an optical grating including a plurality of embedded, slanted optical grating structures.

2. The apparatus of claim 1 wherein the grating structures are embedded within a lithography resist.

3. The apparatus of claim 2 wherein the lithography resist comprises a polymethyl methacrylate resist.

4. The apparatus of claim 2 wherein the grating structures are slanted with respect to outer surfaces of the lithography resist.

5. The apparatus of claim 1 wherein the grating structures are embedded within a material, and wherein the grating structures are slanted with respect to outer surfaces of the material.

6. The apparatus of claim 1 wherein the grating structures are embedded within at least one cured material.

7. The apparatus of claim 1 wherein the grating structures have a refractive index that is higher than a refractive index of a material in which the grating structures are embedded.

8. The apparatus of claim 1 wherein the grating structures are composed of an inorganic material.

9. The apparatus of claim 1 wherein the optical grating is disposed on a support that has a stepped perimeter.

10. The apparatus of claim 9 wherein at least part of the stepped perimeter is covered by a material within which the grating structures are embedded.

11. The apparatus of claim 1 wherein the optical grating is mounted on a flexible layer.

12. The apparatus of claim 11 wherein the flexible layer is composed of a UV-release or thermal-release dicing tape.

13. A method comprising:
pressing a surface of an imprint tool into an imprint material to form an imprinted structure that includes a plurality of grating supports composed of the imprint material, wherein the imprint material is disposed over a substrate, and wherein the grating supports are inclined with respect to a plane of the substrate; and
covering at least a portion of each of the grating supports with a deposition material to form optical grating structures.

14. The method of claim 13 further including:
depositing a backfill material onto the grating supports and the grating structures to cover previously exposed surfaces of the grating structures so that the grating structures are embedded between the imprint material and the backfill material, and are inclined with respect to the plane of the substrate.

15. The method of claim 14 wherein the backfill material has a same composition as the imprint material.

16. The method of claim 13 wherein the deposition material is an inorganic material.

17. The method of claim 13 wherein the imprint material comprises a lithography resist.

18. The method of claim 13 wherein covering at least a portion of each of the grating supports with a deposition material includes performing an angled deposition in which the deposition material is evaporated onto the grating supports.

19. The method of claim 18 wherein performing an angled deposition includes performing resistive or e-beam evaporation.

20. The method of claim 14 wherein the grating structures have a refractive index that is higher than a refractive index of the imprint material and a refractive index of the backfill material.

21. The method of claim 14 further including removing the substrate after depositing the backfill material.

22. The method of claim 13 wherein covering at least a portion of each of the grating supports with a deposition material to form optical grating structures includes covering only a portion of each of the grating supports with the deposition material.
